(19) United States
(12) Patent Application Publication
(10) Pub. No.: US 2015/0106868 A1
(43) Pub. Date: Apr. 16, 2015

(54) SUPERVISORY CONTROLS USING CONTEXTUAL AWARENESS

(71) Applicants: Yuan-Chang Lo, Austin, TX (US); Deeder M. Aurongzeb, Round Rock, TX (US)

(72) Inventors: Yuan-Chang Lo, Austin, TX (US); Deeder M. Aurongzeb, Round Rock, TX (US)

(21) Appl. No.: 14/053,323

(22) Filed: Oct. 14, 2013

(51) Int. Cl. H04L 29/06

(52) U.S. Cl. CPC H04L 63/20
USPC 726/1

(57) ABSTRACT

Methods and systems for supervisory control using contextual awareness on an information handling system may involve receiving policy rules and selection of endorsed activities for supervised users from a primary user. When a supervised user attempts to perform activities on an information handling system, access to the activities may include restricting access until a time budget for endorsed activities has been satisfied. The policy rules may depend upon a usage context for a supervised user, such as location, other users nearby, activity history, user behavior, and/or user physical activity.

### BACKGROUND

1. Field of the Disclosure

This disclosure relates generally to information handling systems and more particularly to supervisory controls for users of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Controlling user access to particular aspects of an information handling system (e.g., access to login to the information handling system, or access to particular applications, features, data, web sites, etc.) is a relevant concern for system administrators. In addition, parents or adults often wish to control children's access to particular aspects of an information handling system, e.g., applications that may include adult or private content.

Existing parental controls for information handling system (e.g., digital television services, computer and video games, or computer software used to access the Internet) typically allow a parent and/or other supervisory adult to simply monitor or limit what a child can see or do and/or time-limit these activities.

### SUMMARY

In one aspect, a disclosed method for supervisory control using contextual awareness executed by at least one processor includes receiving an indication from a secondary user to begin a session on an information handling system, identifying the secondary user and determining a usage context for the secondary user. Based on the usage context and policy rules for supervisory control of the secondary user, the method may include controlling access by the secondary user during the session, including monitoring a first time period spent by the secondary user performing endorsed activities, and restricting access by the secondary user to performing other activities until the first time period exceeds a minimum value. The other activities may be selectable by the secondary user. The policy rules and selection of the endorsed activities may be defined by a primary user exerting the supervisory control on the information handling system over the secondary user. The method may further include recording the usage context and activities performed by the secondary user for the session.

Other disclosed aspects include an article of manufacture supervisory control using contextual awareness comprising a non-transitory computer-readable medium storing instructions executable by a processor subsystem, and an information handling system for supervisory control using contextual awareness comprising a processor subsystem having access to a memory subsystem storing instructions executable by the processor subsystem.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system for supervisory control using contextual awareness;

FIG. 2 is a block diagram of selected elements of an embodiment of a software architecture for supervisory control using contextual awareness;

FIG. 3 is flowchart depicting selected elements of an embodiment of a method for supervisory control using contextual awareness; and

FIG. 4 is flowchart depicting selected elements of an embodiment of a method for supervisory control using contextual awareness.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components. Additionally, the information handling system may include firmware for controlling and/or communicating with, for example, hard drives, network circuitry, memory devices, I/O devices, and other peripheral devices.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

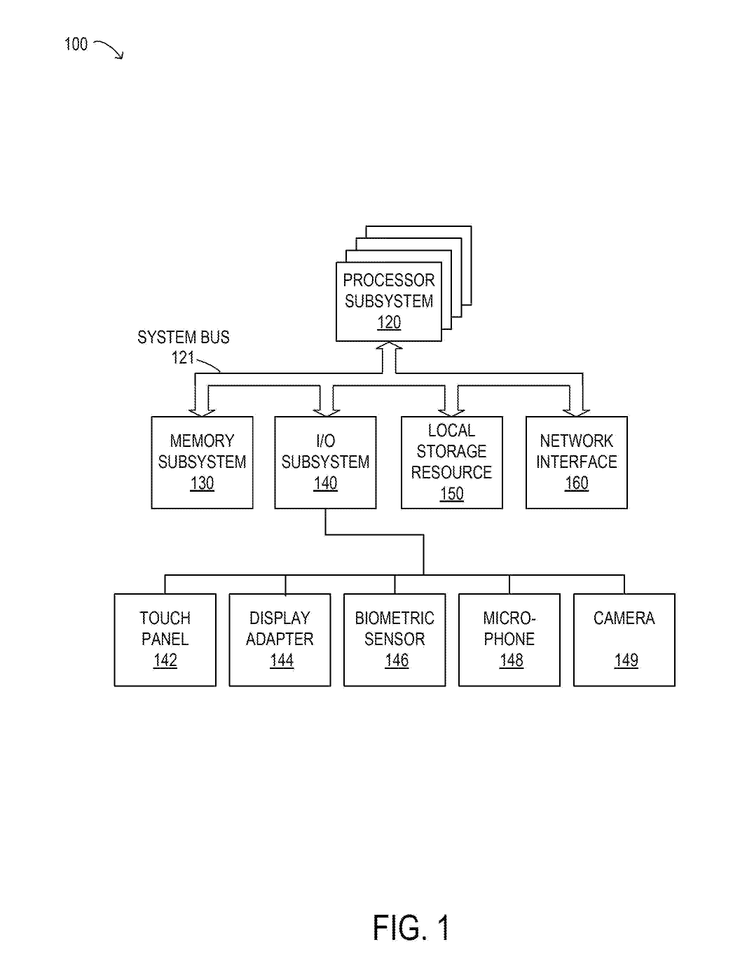

Particular embodiments are best understood by reference to FIGS. 1, 2, 3, and 4 wherein like numbers are used to indicate like and corresponding parts.

Turning now to the drawings, FIG. 1 illustrates a block diagram depicting selected elements of an embodiment of information handling system 100 for data offloading, as described herein. In particular embodiments, information handling system 100 may represent a portable information handling system.

As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network (not shown). Network interface 160 may enable information handling system 100 to communicate over a network using a suitable transmission protocol and/or standard. In some embodiments, network interface 160 may be communicatively coupled via the network to a network storage resource. Network interface 160 may be implemented as, or may be a part of, a storage area network (SAN), personal area network (PAN), local area network (LAN), a metropolitan area network (MAN), a wide area network (WAN), a wireless local area network (WLAN), a personal area network (PAN), a virtual private network (VPN), an intranet, the Internet or another appropriate architecture or system that facilitates the communication of signals, data and/or messages (generally referred to as data). Examples of a WLAN include IEEE 802.11 (e.g., WiFi). Examples of a PAN include Bluetooth™. It is further noted that network interface 160, by itself and/or in conjunction with an external wireless device, may serve as a wireless proximity sensor, for example, to detect and/or identify the presence or the proximity of personal mobile devices associated with users and/or other persons. In one example, a low power consumption wireless PAN interface may be used to communicate with nearby mobile/wireless devices for detection and/or proximity determination. Network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component). In the same or alternative embodiments, processor subsystem 120 may interpret and/or execute program instructions and/or process data stored remotely (not shown).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. In system 100, I/O subsystem 140 may comprise a system, device, or apparatus generally operable to receive and/or transmit data to/from/within system 100. I/O subsystem 140 may represent, for example, a variety of communication interfaces, graphics interfaces, video interfaces, user input interfaces, and/or peripheral interfaces.

As shown in FIG. 1, I/O subsystem 140 may comprise touch panel 142 and display adapter 144. Touch panel 142 may include circuitry for enabling touch functionality using a touchscreen (not shown) in conjunction with a display (not shown) for that is driven by display adapter 144. The touchscreen may be associated with a display and may detect the presence and location of a touch within a display area. The touchscreen may use any type of touchscreen technology, for example, a resistive touchscreen, such as a four-, five-, or eight-wire resistive panel; an acoustic wave or surface acoustic wave (SAW) touchscreen, a capacitive touchscreen; an infrared (IR) touchscreen; a strain gauge touchscreen; an optical imaging touchscreen; a dispersive signal type touchscreen; an acoustic pulse recognition touchscreen; an optical touchscreen based on frustrated total internal reflection; and/or another type of technology for detecting a touch within a display area.

Additionally, I/O subsystem 140 is shown in FIG. 1 comprising biometric sensor 146, microphone 148, and camera 149. Biometric sensor 146 may be used to identify users of information handling system 100 based on a biometric characteristic, such as a fingerprint, retinal scan, blood vessel pattern, etc. Microphone 148 and camera 149 may also be used to identify users, for example, using voice recognition (microphone 148) and/or facial recognition (camera 149). It is noted that information handling system 100 may be enabled to automatically recognize at least one current user using one or more devices coupled to I/O subsystem 140, as will be described in further detail.

In operation of information handling system 100 for supervisory control using contextual awareness, as shown in FIG. 1, a “primary user” (e.g., a parent, a guardian, a caregiver, a babysitter, an administrator, etc.) may be responsible for supervising the interaction of a “secondary user” (e.g., a child, a minor, a non-administrator user, a monitored person, a restricted user, etc.) with information handling system 100. Specifically, the primary user may desire to oversee and/or control access of the secondary user to web content, multimedia content, Internet-protocol services, web browsers, communication with remote users, and/or local applications (i.e., apps) when the secondary user is using information handling system 100. Furthermore, the primary user may wish not only to block undesired content and/or undesired online activity of the secondary user, but may also seek to direct the secondary user to endorsed content and/or endorsed activities, as will be described in further detail below.

In given embodiments, the primary user may be a parent or a guardian for at least one secondary user(s) who may be children. Accordingly, information handling system 100 may be used for supervisory control using contextual awareness in a collaborative and/or family setting. For example, the primary user may observe, sometimes intermittently or from a distance, the usage of information handling system 100 by one or more secondary users. To detect which users are subject to supervisory control, information handling system 100 may be enabled to detect proximity of a user, such as the secondary user, and may further be enabled to discriminate a particular user when multiple persons and/or users are in vicinity of information handling system 100. In other instances, the primary user may be in a remote location when the secondary user uses information handling system 100. It will be understood that other usage scenarios (e.g., education, workplace, seminar, convention, residential environment, hospitality, transportation, medical care, incarceration, etc.) where the primary user and the secondary user are not family members, may also be applicable to the usage of information handling system 100, as described herein. To implement supervisory control, the proximity of a secondary user may be detected by information handling system 100 using wireless means, as described herein. The primary user may accordingly be able to activate (i.e., wake from a dormant state) or deactivate (i.e., place in a dormant state or shut down) information handling system 100 and/or supervisory control of information handling system 100 using a remote connection, while the secondary user is automatically detected and desired supervisory controls for a particular secondary user are enforced.

In operation, a secondary user may desire to initiate a session on information handling system 100, the session representing a usage period for the secondary user. Information handling system 100 may implement supervisory control using contextual awareness by being aware of a usage context within which the request by the secondary user is received. The usage context may include a location where the session is being initiated, as well as locations of other users and/or persons that may be in the vicinity, including the primary user, additional secondary users, and/or other persons not recognized as users of information handling system 100. In some embodiments, information handling system 100 may employ a WLAN and/or a PLAN interface to detect the presence and, in selected instances, the proximity of mobile devices personally associated with the other users/persons to detect a location of the other users/persons. The usage context may include awareness by information handling system 100 of the secondary user, obtained by identifying the secondary user when the secondary user is operating information handling system 100. In this manner, information handling system 100 may be enabled to implement supervisory controls without having users explicitly logon to a user account, for example, by using a user identifier and/or a password.

In addition to user locations and user identification, the usage context may also include an activity history for users. In other words, information handling system 100 may be enabled to record and analyze an activity history for users, including the primary user and secondary user(s). For example, information handling system 100 may record a history of usage of devices, apps, and/or web content, including frequency of usage, duration of usage (e.g., sessions), and/or most recent usage activity, for example, among other types of usage. Based on the indications of location and user activity, the usage context may further include behavior of different users with respect to various information handling systems. For example, information handling system 100 may be enabled to infer user behavior, such as collaboration and/or shared usage of particular devices and/or apps. Furthermore, the usage context may include user physical activity. In particular embodiments, information handling system 100 may be enabled to monitor and/or track user physical activity, for example, by identifying and accessing user wearable devices that record physical activity (e.g., exercise, walking, running, sports, etc.) to track a physical activity level of a user, in real time and/or from historical data. Examples of sensors in such user wearable devices may include accelerometers, gyroscopes, global positioning system (GPS) sensors, temperature sensors, physiological sensors (e.g., heart beat, breathing, sweat level, blood pressure, etc.). In certain instances, information handling system 100 may be configured to access user data recorded using a user wearable device, for example, on a server hosted by a manufacturer of the user wearable device.

Upon receiving the request from the secondary user to initiate the session, information handling system 100 may implement supervisory control using contextual awareness by relying on policy rules provided by the primary user for the secondary user, as will be described in further detail. The policy rules may include various criteria with respect to selected aspects of the usage context, as described above. Rather than simply providing rules to block undesired content and/or activities, the policy rules may induce the secondary user to engage in endorsed activities. For example, the primary user may allocate, using the policy rules, a time budget for various classes or types of activity that a secondary user engages in by using information handling system 100. The time budget may be applied for the secondary user when information handling system 100 detects usage by the secondary user, as described previously. One example of a time budget is given below in Table 1.

TABLE 1
Policy rules for supervisory control: time
budgets for different kinds of user activity.

| Activity | Time Budget |
|---|---|
| Collaboration | 30% |
| Education | 30% |
| Physical | 30% |
| Free Time | 10% |

In Table 1, three kinds of user activity are enumerated: Collaboration (30%); Education (30%); Physical (30%); and Free Time (10%). In this example, it may be assumed that collaboration, education, and physical activities represent desirable and/or endorsed activities, while free time may include other types of activities that are not necessarily endorsed by the primary user, but are desired by the secondary user. Thus, to enforce the time budget, information handling system 100 may limit usage of the secondary user that is not recognized as collaboration, education, or physical to 10% (free time) of the total usage time. In particular embodiments, collaboration may be inferred by detecting the presence of other persons when the secondary user is actively using information handling system 100. The detection and/or identification of the secondary user and/or other persons (e.g., additional secondary users that are peers of the secondary user) may be performed using an audio sensor, an image sensor, a wireless proximity sensor and/or a biometric sensor, as described herein.

The usage time may be applied over a predetermined time period (per day, week, month, etc.) or may be applied to a given session for the secondary user. It is also noted that the time budget may be expressed in terms of a total time in percentages, as shown in Table 1, or in terms of absolute time (i.e., hours or minutes) for individual activities and/or a total time. Different secondary users may be allocated individualized time budgets by the primary user. It is noted that the time budget shown in Table 1 is an exemplary embodiment and that different numbers of categories and values for time budgets may be implemented in different embodiments.

The classification of the activities given by a time budget may be indicated by broad categories of activity (e.g., collaboration, educational) as shown, or may be indicated by entering specific activities (e.g., a given app, a given web site, a given game, etc.). Furthermore, the enforcement of the time budget may be implemented with respect to a maximum value for free time activity, rather than limiting endorsed activities. In other words, the time budget for endorsed activities may not be limited to a maximum time, while the time budget for free time may be limited according to the policy rules. Also, the time budget may be implemented with respect to a minimum time for certain endorsed activities. For example, usage of information handling system 100, or certain activities thereon, may be limited or blocked depending on a minimum time actually spent by the secondary user for certain endorsed activities, such as, for example, physical activities.

In addition to the time budget shown above in Table 1, other constraints and options regarding user activity may be implemented. For example, when no free time is available to the secondary user, the secondary user may have an option to engage in endorsed activities, such as collaboration with another secondary user, to ‘buy’ an additional budget for free time. For example, in the family setting, collaboration between two secondary users who are siblings may represent an endorsed activity for either or both of the secondary users. The time budgets for different types of activity may be based on a classification of specific apps and digital content as types of activities. Certain activities may be classified into more than one type. For example, when two secondary users collaborate to solve a math problem, such activity may be counted towards either collaboration or education time budgets or both, as desired by the primary user.

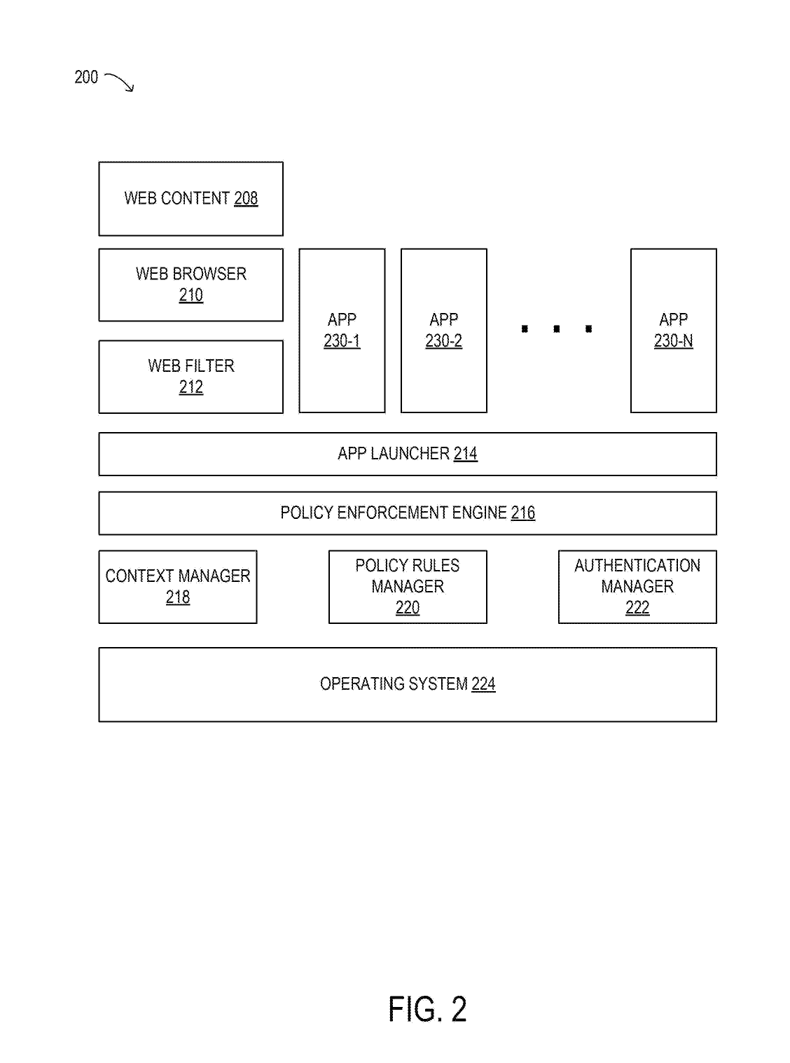

Turning now to FIG. 2, a block diagram of selected elements of an embodiment of software architecture 200 for supervisory control using contextual awareness is illustrated. In FIG. 2, software architecture 200 may represent various components including executable code and/or instructions for execution by at least one processor of an information handling system, such as information handling system 100 (see FIG. 1).

In FIG. 2, software architecture 200 is shown including operating system 224, which may represent an execution environment in which other components of software architecture 200 may be executed and/or may be specific to. Operating system 224 may be UNIX or be based on UNIX (e.g., a LINUX variant), one of a number of variants of Microsoft Windows® operating systems, a mobile device operating system (e.g., Google Android™ platform, Apple® iOS, among others), an Apple® MacOS operating system, an embedded operating system, a gaming operating system, or another suitable operating system.

As shown in FIG. 2, software architecture 200 may further include context manager 218, policy rules manager 220, and authentication manager 222. Context manager 218 may be responsible for sourcing information describing the usage context, as described previously herein. Accordingly, context manager 218 may receive various inputs and manage various types of information associated with supervisory control using contextual awareness. Context manager 218 may monitor and track location information, such as locations of information handling systems, including personal mobile devices, and associate the tracked information handling systems and location information to individual users. Context manager 218 may monitor and track users in proximity to a secondary user, including a primary user, for example, by using location information and/or by using sensor inputs to perform recognition functions, such as voice recognition (audio sensor), facial recognition (image sensor), an/or biological recognition (biometric sensor). The location information of users and/or persons in a vicinity of information handling system 100 may be also be used for security purposes, for example to discriminate a given secondary user subject to supervisory control when other users are present nearby. For example, wireless proximity detection of personal mobile devices associated with individual persons may be used to detect presence of desired parties (i.e., the given secondary user) while also detecting presence of other parties (i.e., other users, unrecognized persons, etc.). In this manner, context manager 218 may enable additional awareness by information handling system 100 of persons nearby for providing secure and reliable supervisory control. Furthermore, context manager 218 may monitor and store activity history for individual users, such as a secondary user, the activity including activity using an information handling system and physical activity (e.g., exercise, sports, outdoor time, games, etc.) using a physical activity sensor, as described previously. Context manager 218 may monitor and track user behavior, such as an amount of time an activity is performed, whether an activity involves collaboration with other users, and/or an amount of time since an activity (or type of activity) was performed.

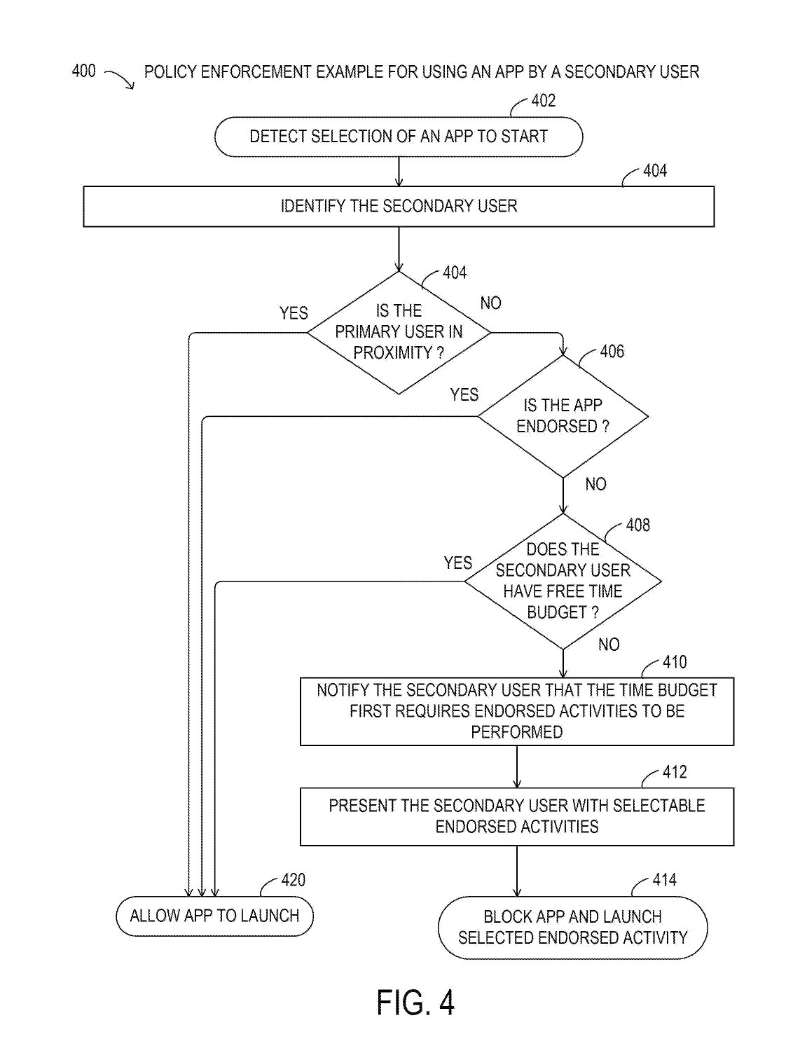

In FIG. 2, policy rules manager 220 may receive policy rules for supervisory control using contextual awareness from a primary user for at least one secondary user. The policy rules may specify conditions under which a secondary user may perform which activities using an information handling system (see also FIG. 4 for an example of a policy rule). The policy rules and/or specification of endorsed activities may be specified by the primary user by providing inputs to policy rules manager 220, which may then output specific policies (e.g., usage time, types of activities, duration of activities, time budgets, etc.) for enforcement by policy enforcement engine 216, which may monitor usage of an information handling system and intervene to control usage of a secondary user. Authentication manager 222 may be responsible for determining one or more users of an information handling system, as described above using sensor inputs, for example. Authentication manager 22 may further store user profiles (not shown) that include various attributes of individual users, such as, age, gender, preferences, as examples among other attributes. App launcher 214 may control (or block) launching of specific apps 230, shown in FIG. 2 as apps 230-1, apps 230-2, and so on, up to apps 230-N, where N is a number of apps installed on an information handling system. Web filter 212 may control access to web content 208 provided by web browser 210, which may be used to access the World Wide Web (WWW) using universal resource locators (URLs).

It is noted that in addition to the restrictions described herein with respect to endorsed activities when performing supervisory control using contextual awareness, global restrictions for secondary users may be applied (e.g., as options in the policy rules), including to free time, based on global policy rules and user profile information. For example, secondary users under the age of 18 may be globally prevented from performing any activities associated with adult content on an information handling system, regardless of a time budget for free time. Also, a global list of allowed apps may be used to restrict what activities a secondary user may select, even during free time, such that the global list of allow apps represents at least some endorsed activities, as well as other types of activities (i.e., games, multimedia content, etc.).

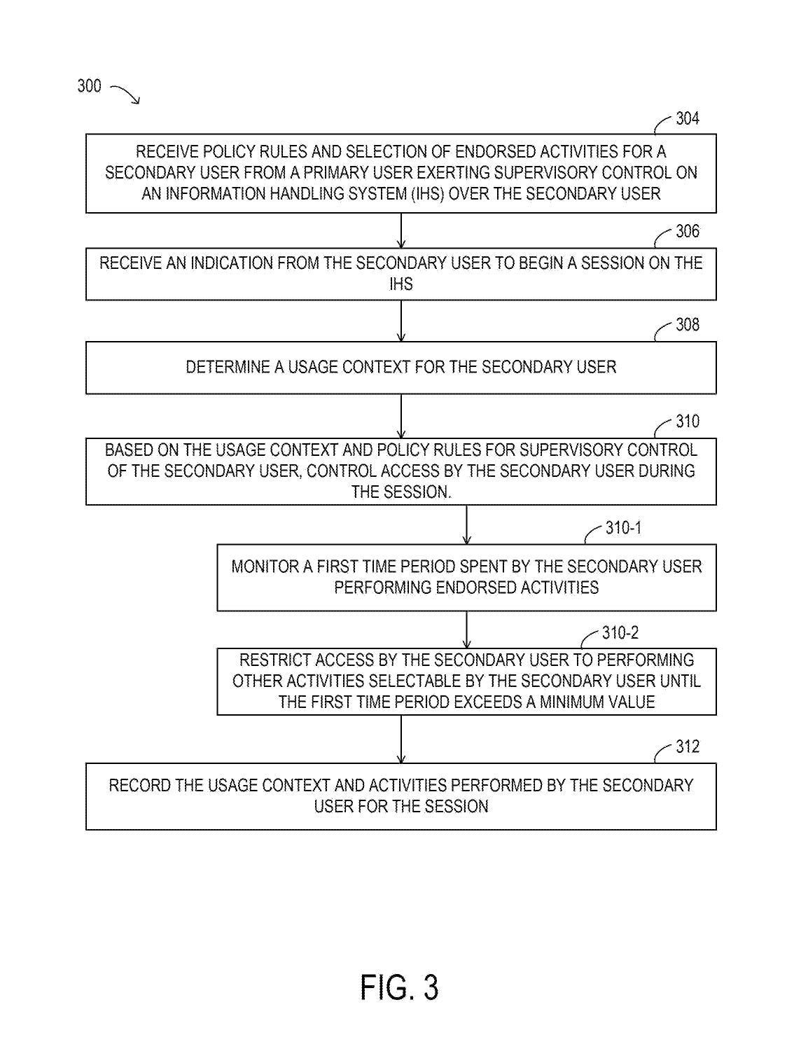

Referring now to FIG. 3, a block diagram of selected elements of an embodiment of method 300 for supervisory control using contextual awareness, as described herein, is depicted in flowchart form. Method 300 may be performed using software architecture 200 and/or information handling system 100 (see FIGS. 1 and 2) for example. It is noted that certain operations described in method 300 may be optional or may be rearranged in different embodiments.

Method 300 may begin with receiving (operation 304) policy rules and selection of endorsed activities for a secondary user from a primary user exerting supervisor control on an information handling system over the secondary user. The policy rules may include at least one of: a time budget for performing the endorsed activities, a time budget for performing other activities, a specification of selectable endorsed activities, and a minimum value of a time period spent performing endorsed activities. An indication may be received (operation 306) from the secondary user to begin a session on the information handling system. A usage context may be determined (operation 308) for the secondary user. The usage context may include at least one of: a location of the information handling system during the session, a proximity of the primary user to the information handling system, a proximity of other secondary users to the information handling system, a usage history of information handling systems, including the information handling system, by the secondary user, and a level of physical activity of the secondary user. Based on the usage context and policy rules for supervisory control of the secondary user, access by the secondary user may be controlled (operation 310) during the session. In certain embodiments, operation 310 may further include operations 310-1 and 310-2. A first time period spent by the secondary user performing endorsed activities may be monitored (operation 310-1). Access by the secondary user to performing other activities selectable by the secondary user may be restricted (operation 310-2) until the first time period exceeds a minimum value. The usage context and activities performed by the secondary user may be recorded (operation 312) for the session.

Referring now to FIG. 4, a block diagram of selected elements of an embodiment of method 400 for policy enforcement using an app by a secondary user as an example of supervisory control using contextual awareness, as described herein, is depicted in flowchart form. Method 400 may be performed using software architecture 200 and/or information handling system 100 (see FIGS. 1 and 2) for example. It is noted that certain operations described in method 400 may be optional or may be rearranged in different embodiments. It is noted that method 400 may be performed during the session described in method 300 (see FIG. 3).

Method 400 may begin by detecting (operation 402) selection of an app to start. Then, the secondary user may be identified (operation 404). It is noted that operation 404 may be repeated, as desired, during various operations and methods described herein, for confirming and/or updating an identity of a user or users of an information handling system. Then, a decision may be made whether the primary user is in proximity (operation 404). When the result of operation 404 is NO, a decision may be made whether the app is endorsed (operation 406). When the result of operation 406 is NO, a decision may be made whether the secondary user has a free time budget (operation 408). When the result of operation 408 is NO, the secondary user may be notified (operation 410) that the time budget first requires endorsed activities to be performed. The secondary user may then be presented (operation 412) with selectable endorsed activities. Then, method 400 may terminate by blocking the app and launching (operation 414) the selected endorsed activity. When any of the results of operations 404, 406, or 408 are YES, method 400 may terminate by allowing (operation 420) to launch.

As described in detail above, disclosed methods and systems for supervisory control using contextual awareness on an information handling system may involve receiving policy rules and selection of endorsed activities for secondary users from a primary user. When a secondary user attempts to perform activities on an information handling system, access to the activities may include restricting access until a time budget for endorsed activities has been satisfied. The policy rules may depend upon a usage context for a secondary user, such as location, other users nearby, activity history, user behavior, and user physical activity.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for supervisory control using contextual awareness executed by at least one processor comprising:
receiving an indication from a secondary user to begin a session on an information handling system;
identifying the secondary user;
determining a usage context for the secondary user;
based on the usage context and policy rules for supervisory control of the secondary user, controlling access by the secondary user during the session, including:
monitoring a first time period spent by the secondary user performing endorsed activities; and
restricting access by the secondary user to performing other activities until the first time period exceeds a minimum value, wherein the other activities are selectable by the secondary user,
wherein the policy rules and selection of the endorsed activities are defined by a primary user exerting the supervisory control on the information handling system over the secondary user.

2. The method of claim 1, wherein identifying the second user includes:
using a sensor to detect when the secondary user is present at the information handling system, wherein the sensor is selected from at least one of:
an audio sensor;
an image sensor;
a wireless proximity sensor; and
a biometric sensor.

3. The method of claim 1, wherein the usage context for the secondary user includes at least one of:
a location of the information handling system during the session;
a proximity of the primary user to the information handling system;
a proximity of other secondary users to the information handling system;
a usage history of information handling systems, including the information handling system, by the secondary user; and
a level of physical activity of the secondary user.

4. The method of claim 1, wherein the policy rules include at least one of:
a time budget for performing the endorsed activities;
a time budget for performing the other activities;
a specification of selectable endorsed activities; and
the minimum value.

5. The method of claim 4, wherein the selectable endorsed activities include:
educational activities;
collaboration with other users of the information handling system;
physical activities; and
specifically defined activities.

6. The method of claim 1, wherein activities performed on the information handling system by the secondary user include:
accessing web content;
accessing multimedia content;
using Internet-protocol services;
using a web browser;
communicating with remote users; and
executing local applications on the information handling system.

7. The method of claim 1, further comprising:
recording the usage context and activities performed by the secondary user for the session.

8. An article of manufacture comprising a non-transitory computer-readable medium storing instructions, that, when executed by a processor subsystem, cause the processor subsystem to:
receive an indication from a secondary user to begin a session on an information handling system;
identify the secondary user;
determine a usage context for the secondary user;
based on the usage context and policy rules for supervisory control of the secondary user, control access by the secondary user during the session, including instructions to:
monitor a first time period spent by the secondary user performing endorsed activities; and
restrict access by the secondary user to performing other activities until the first time period exceeds a minimum value, wherein the other activities are selectable by the secondary user,
wherein the policy rules and selection of the endorsed activities are defined by a primary user exerting the supervisory control on the information handling system over the secondary user.

9. The article of manufacture of claim 8, wherein the instructions to identify the second user include instructions to:
use a sensor to detect when the secondary user is present at the information handling system, wherein the sensor is selected from at least one of:
an audio sensor;
an image sensor;
a wireless proximity sensor; and
a biometric sensor.

10. The article of manufacture of claim 8, wherein the usage context for the secondary user includes at least one of:
a location of the information handling system during the session;
a proximity of the primary user to the information handling system;
a proximity of other secondary users to the information handling system;
a usage history of information handling systems, including the information handling system, by the secondary user; and
a level of physical activity of the secondary user.

11. The article of manufacture of claim 8, wherein the policy rules include at least one of:
a time budget for performing the endorsed activities;
a time budget for performing the other activities;
a specification of selectable endorsed activities; and
the minimum value.

12. The article of manufacture of claim 11, wherein the selectable endorsed activities include:
educational activities;
collaboration with other users of the information handling system;
physical activities; and
specifically defined activities.

13. The article of manufacture of claim 8, wherein activities performed on the information handling system by the secondary user include:
accessing web content;
accessing multimedia content;
using Internet-protocol services;
using a web browser;
communicating with remote users; and
executing local applications on the information handling system.

14. The article of manufacture of claim 8, further comprising instructions to:
record the usage context and activities performed by the secondary user for the session.

15. An information handling system comprising:
a processor subsystem having access to a memory subsystem, wherein the memory subsystem stores instructions executable by the processor subsystem, that, when executed by the processor subsystem, cause the processor subsystem to:
receive an indication from a secondary user to begin a session on an information handling system;
identify the secondary user;
determine a usage context for the secondary user;
based on the usage context and policy rules for supervisory control of the secondary user, control access by the secondary user during the session, including instructions to:
monitor a first time period spent by the secondary user performing endorsed activities; and
restrict access by the secondary user to performing other activities until the first time period exceeds a minimum value, wherein the other activities are selectable by the secondary user,
wherein the policy rules and selection of the endorsed activities are defined by a primary user exerting the supervisory control on the information handling system over the secondary user.

16. The information handling system of claim 15, wherein the instructions to identify the second user include instructions to:
use a sensor to detect when the secondary user is present at the information handling system, wherein the sensor is selected from at least one of:
an audio sensor;
an image sensor;
a wireless proximity sensor; and
a biometric sensor.

17. The information handling system of claim 15, wherein the usage context for the secondary user includes at least one of:
a location of the information handling system during the session;
a proximity of the primary user to the information handling system;
a proximity of other secondary users to the information handling system;
a usage history of information handling systems, including the information handling system, by the secondary user; and
a level of physical activity of the secondary user.

18. The information handling system of claim 15, wherein the policy rules include at least one of:
a time budget for performing the endorsed activities;
a time budget for performing the other activities;
a specification of selectable endorsed activities; and
the minimum value.

19. The information handling system of claim 18, wherein the selectable endorsed activities include:
educational activities;
collaboration with other users of the information handling system;
physical activities; and
specifically defined activities.

20. The information handling system of claim 15, wherein activities performed on the information handling system by the secondary user include:
accessing web content;
accessing multimedia content;
using Internet-protocol services;
using a web browser;
communicating with remote users; and
executing local applications on the information handling system.

21. The information handling system of claim 15, further comprising instructions to:
record the usage context and activities performed by the secondary user for the session.
